(19) United States
(12) Patent Application Publication
(10) Pub. No.: US 2025/0205606 A1
(43) Pub. Date: Jun. 26, 2025

(54) ADAPTIVE DECISION REQUESTING FOR MACHINE LEARNING-BASED SYSTEMS

(71) Applicants: Advanced Micro Devices, Inc., Santa Clara, CA (US); ATI Technologies ULC, Markham (CA)

(72) Inventors: Alexander Walter Cann, Markham (CA); Ian Charles Colbert, San Diego, CA (US); Zachariah Louis Vincze, Toronto (CA); Mehdi Saeedi, Markham (CA)

(73) Assignees: Advanced Micro Devices, Inc., Santa Clara, CA (US); ATI Technologies ULC, Markham (CA)

(21) Appl. No.: 18/394,331

(22) Filed: Dec. 22, 2023

(51) Int. Cl. A63F 13/67; A63F 13/56

(52) U.S. Cl. CPC A63F 13/67; A63F 13/56

(57) ABSTRACT

A technique includes determining a base decision rate; monitoring for key events; and based on the base decision rate and the monitoring, determining a time at which to generate an action to be performed by an application entity of an application. The base decision rate includes a baseline rate at which the application is directed to determine new actions to be performed by the application entity. In some examples, the base decision rate is determined using a trained AI model, by applying information about the state of the application to the model and obtaining the base decision rate in response. In some examples, key events are unexpected events that occur in the application. In some examples, since the base decision rate represents a rate at which to generate actions, given the current state of the application, the key events, which represent unexpected events, override or modify the base decision rate.

### BACKGROUND

Machine learning is a large family of techniques that attempt to automatically generate algorithms for solving problems through a training process. Often, machine learning algorithms utilize artificial neural networks as the basis for the algorithms. A wide variety of neural network-based machine learning techniques exist and are being developed.

### BRIEF DESCRIPTION OF THE DRAWINGS

A more detailed understanding can be had from the following description, given by way of example in conjunction with the accompanying drawings wherein:

FIGS. 1A and 1B are block diagrams of example devices in which one or more features of the disclosure may be implemented;

FIG. 2A is a block diagram of an artificial intelligence (AI) system, according to an example;

FIGS. 2B-2C are example implementations of the AI system of FIG. 2A;

FIG. 3 illustrates operation of the action rate controller, according to an example;

FIG. 4 illustrates a reinforcement learning system, according to an example;

FIG. 5 is a flow diagram illustrating operations for determining what actions may be performed by an application entity, according to an example;

FIG. 6 is a flow diagram of a method for determining whether to identify an action for an application entity such as a non-player character in a video game, according to an example.

### DETAILED DESCRIPTION

A technique includes determining a base decision rate; monitoring for key events; and based on the base decision rate and the monitoring, determining a time at which to generate an action to be performed by an application entity of an application. The base decision rate includes a baseline rate at which the application is directed to determine new actions to be performed by the application entity. In some examples, the base decision rate is determined using a trained AI model, by applying information about the state of the application to the model and obtaining the base decision rate in response. In some examples, key events are unexpected events that occur in the application. In some examples, since the base decision rate represents a rate at which to generate actions, given the current state of the application, the key events, which represent unexpected events, override or modify the base decision rate.

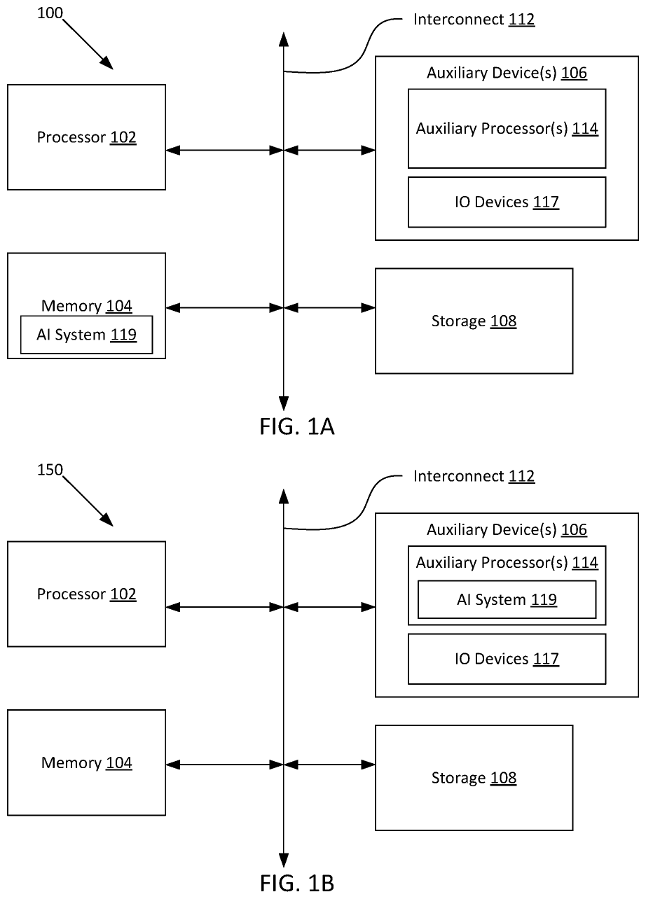

FIGS. 1A and 1B are block diagrams of an example device 100 and an example device 150 in which one or more features of the disclosure may be implemented. Device 100 and device 150 are similar except that the AI system 119 is illustrated as software (and thus in memory 104) in FIG. 1A and as hardware (as part of the auxiliary processors 114) in FIG. 1B. Although specific example implementations for the AI system 119 are described, it should be understood that the teachings of the present disclosure are not limited to such implementations.

In various examples, the device 100 includes a computer, a gaming device, a handheld device, a set-top box, a television, a mobile phone, or a tablet computer. The device 100 includes a processor 102, a memory 104, a storage 108, one or more auxiliary devices 106, one or more auxiliary processors, and one or more IO devices 117. It is understood that the device 100 may include additional components not shown in FIG. 1A.

In various alternatives, the processor 102 may include, but is not limited to, a central processing unit (CPU), a graphics processing unit (GPU), a CPU and GPU located on the same die, one or more processor cores, wherein each processor core may be a CPU or a GPU, inference processing units (“IPUs”), or others. In some alternatives, the processor 102 may include or be embodied as a Field Programmable Gate Array (FPGA). In various alternatives, the memory 104 may be located on the same die as the processor 102, or may be located separately from the processor 102. The memory 104 may include a volatile or non-volatile memory, for example, random access memory (RAM), dynamic RAM, or a cache.

The storage 108 includes a fixed or removable storage, for example, a hard disk drive, a solid state drive, an optical disk, or a flash drive. The auxiliary devices 106 include one or more auxiliary processors 114 and/or one or more input/output devices 117, which include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), a display, a speaker, a printer, a haptic feedback device, one or more lights, an antenna, or a network connection (e.g., a wireless local area network card for transmission and/or reception of wireless IEEE 802 signals).

The device 100 includes an artificial intelligence (Al) system 119. In various examples, the AI system 119 is implemented as software configured to execute on the processor 102, a hardware device (e.g., as one of the auxiliary processors 114), or as any other of software, hardware (e.g., circuitry, such as one or more of any type of processor include a programmable processor, fixed function processor, FPGA, fixed function circuitry, or any other circuitry), or combination thereof. Although shown in the alternative as software loaded into the memory 104 (FIG. 1A) and executed within the processor 102 or as a hardware device that is an auxiliary processor 114 (FIG. 1B), the AI system 119 could be implemented as a combination thereof or in any other technically feasible manner.

In some examples, the AI system 119 is configured to control agents within a software application (e.g., a software application executing on the processor 102, on an auxiliary processor 114 such as a GPU, or a combination thereof). In some examples, the agents have the ability to perform actions within the software application. In this document, the “agents” are sometimes referred to as “application entities.” In some examples, the agents are characters such as non-player characters and the application is a video game. In some examples, the AI system 119 makes decisions on which action one or more agents should take within the application, based on the state of the application. The actions that may be taken by the agents are defined by the application. In an example where the application is a video game, some example actions include jumping, attacking, using items, or other actions.

In some examples, the AI system 119 is configured to control a very large number of agents within the software application. Because making a determination as to which action an agent should perform is resource-intensive, the AI system 119 performs performance-aware decision rate control. While increasing the rate at which these decisions are made has the ability to improve the “performance” of the agents in the context of the application (for example, non-player characters would react to environmental changes more frequently), increasing the frequency at which these decisions are made may reduce the overall performance of the system, including of the application itself. In an example, making such decisions too frequently may cause the frame rate of a video game to drop, as the processing resources used for making agent control decisions cannot be used for other operations of the application. Thus, the present disclosure provides techniques for selectively throttling (rate-limiting) such decisions based on the state of the software application itself. In other words, although a naive implementation would be to make such decisions as often as possible, the processing involved for such decision making can be very high. Thus, it is advantageous to reduce the rate of performing such decision making, as compared with simply making such decisions as fast as possible.

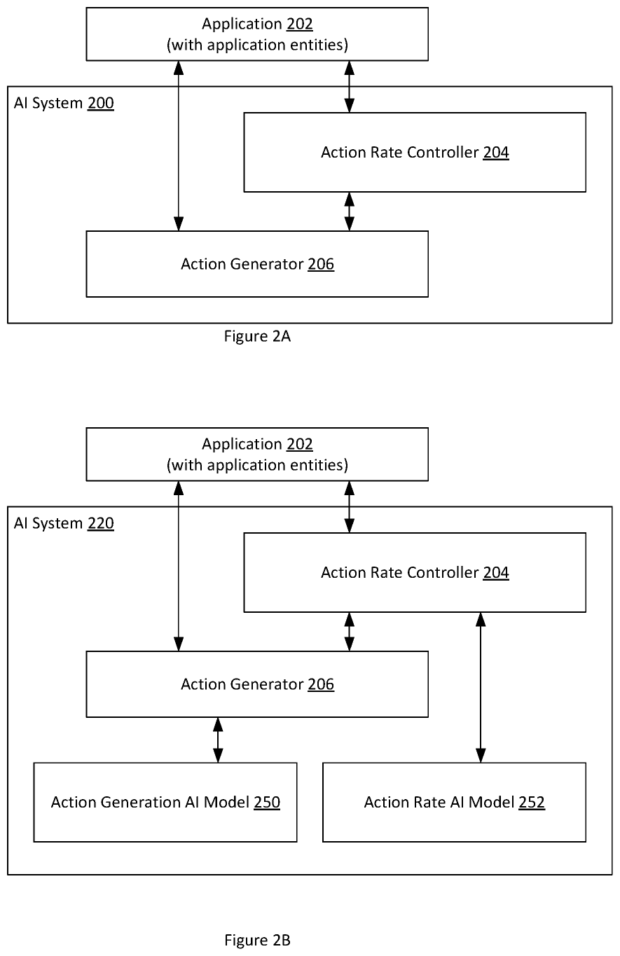

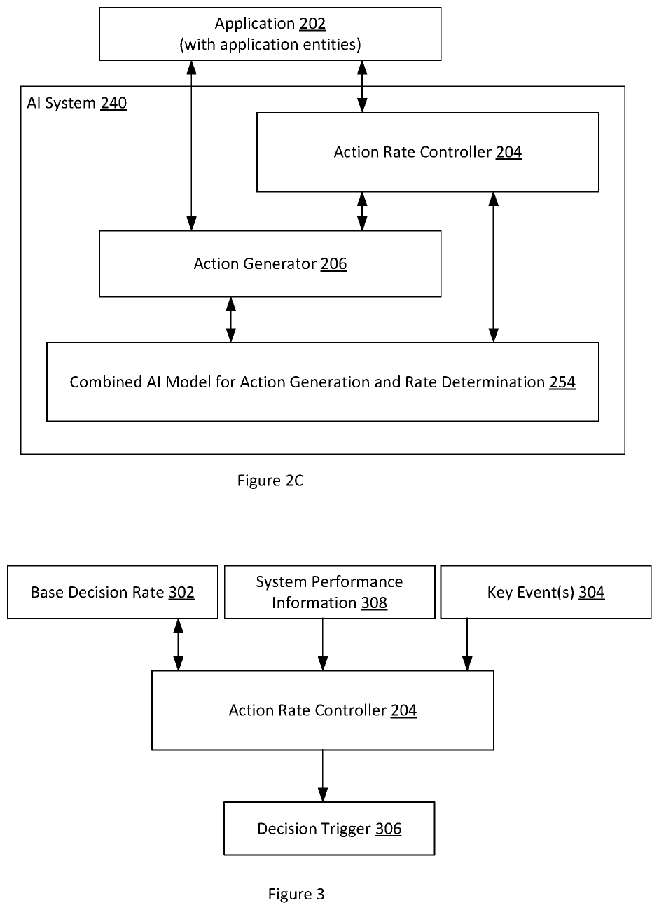

FIG. 2A is a block diagram of an AI system 200, according to an example. The AI system 200 of FIG. 2A is an example of the AI system 119 of FIG. 1. Although specific elements of the AI system 200 are illustrated, these should not be understood as limiting.

The AI system 200 includes an action rate controller 204 and an action generator 206. These two elements of the AI system 200 are in communication with an application 202, which, in some instances, is the application described above. Among other things, the application 202 maintains and updates application state. The application state is data that describes any of a variety of elements of the application 202 itself. In an example where the application 202 is a video game, the application 202 updates the “game world,” and the game world is or is included in the application state. In such examples, this state includes representations of objects and entities that may be updated and may interact with each other. Although a video game is given as one example of the application 202, the application is not limited to a video game.

The application 202 includes one or more entities that are able to perform actions. The action generator 206 generates actions to be performed by these entities. In some examples, the action generator 206 includes a trained AI model that the action generator 206 activates to generate the actions for the entities. In some examples, the application 202 includes a large number of entities and the action generator 206 generates actions for each such entity.

Generating actions for the entities to perform is a performance intensive operation. Therefore, the action rate controller 204 controls the rate at which the action generator 206 generates the actions for one or more entities of the application 202. In some examples, the action rate controller 204 controls this rate based on a prediction of how long a previously determined action will be valid for (where this prediction is, in some examples, made using a trained AI model), as well as observation of “key events,” which are unpredictable events that indicate that a new action needs to be determined. The prediction for how long an action will be valid for is sometimes referred to herein as a “base decision rate.” Additional details regarding how the action rate controller 204 controls this rate are provided elsewhere herein.

The application 202 is a software application configured to execute on a processor such as the processor 102 and/or another processor. In some examples, the functionality of the application 202 is implemented partially or fully in hardware (e.g., as circuitry, such as a programmable processor, a fixed-function processor, analog circuitry, or as a combination of any type of circuitry and/or software). The action generator 206 and action rate controller 204 are implemented as software executing on a processor, hardware (e.g., a circuit such as a processor, fixed function circuit, or other type of circuit or hardware), or a combination thereof (such as a combination of a hardware accelerator and software).

FIGS. 2B and 2C illustrate alternative example implementations for the AI system 200. In FIG. 2B, an AI system 220 is illustrated that includes a separate action generation AI model 250 and action rate AI model 252. In FIG. 2C, an AI system 240 is illustrated that includes a combined AI model for action generation and rate determination 254.

It should be understood that the action generation AI model 250, the action rate AI model 252, and the combined AI model for action generation and rate determination 254 represent hardware (e.g., circuitry, such as a processor, fixed function circuitry, or other type of circuit or hardware), software, or a combination thereof. Such models utilize operations performed by one or more processors and data maintained by one or more processors, to process inputs and generate outputs described herein. Any of a wide variety of AI models may be used. In various examples, such AI models include one or more artificial neurons, each of which accepts weighted inputs, applies a transformation function and provides an output. Such AI models may include multiple layers, each of which includes multiple sets of artificial neurons and/or performs operations not performed by artificial neurons such as filtering, pooling, or other operations. The present disclosure contemplates a wide variety of hardware implementations for any of the AI models, such as single processor implementations (where a single processor processes all aspects of the model), multi-processor implementations (where multiple processors cooperate to process all such aspects), heterogeneous processor implementations (where different types of processors cooperate to process such aspects), cloud-based implementations (where dynamically assignable processors communicating over a network cooperate to process such aspects), or any other technically feasible implementation.

The idea that the action generation AI model 250 and action rate AI model 252 are separate is contrasted with the combined AI model 254. In the separate models, different sets of AI model layers are trained and capable of providing their respective outputs (e.g., the action rate and the action). In the combined model, a single set of AI model layers provides both outputs. It should be understood that the action rate generation refers to generation of the base decision rate 302 as discussed elsewhere herein (e.g., FIG. 3) and the action generation refers to generation of an action to be performed by an application entity in the application 202, as described elsewhere herein.

FIG. 3 illustrates operation of the action rate controller 204, according to an example. The action rate controller 204 determines a base decision rate 302 and accepts one or more key events 304 and system performance information 308, processes the base decision rate 302, system performance information 308, and key events 304, and, determines whether to generate a decision trigger 306 based on this processing. The decision trigger 306 is an indication to the action generator 206 that the action generator 206 is directed to generate an action for a particular entity within the application 202.

The base decision rate 302 is an indication of a frequency with which the action generator 206 should generate actions for a particular entity, given the status of that entity. In an example where an entity is a video game non-player character, the current state and environment of that non-player character may dictate a base decision rate 302. In an example, where a video game non-player character is walking in the environment and does not encounter any enemies, the base decision rate 302 is lower than in a situation in which the video game non-player character is engaged in high speed combat. In some examples, the action rate controller 204, itself, determines the base decision rate 302, based on the state of the application related to a particular application entity. The action rate controller 204 uses any technically feasible mechanism to make this determination. In various examples, the action rate controller 204 uses hard-coded rules, one or more lookup tables, or a trained AI model to generate the base decision rate 302. More specifically, in some examples, the action rate controller 204 accepts as input, state information about the entity for which the decision base decision rate 302 is being determined and/or other state information from the application 202 that is not directly related to the entity, processes that state information through the mechanism, and outputs a base decision rate 302. In one example, the action rate controller 204 provides the state information to a trained AI model, which processes that information and provides a base decision rate 302 in response. In some examples, the trained AI model that generates base decision rates 302 is the same AI model as a model that the action generator 206 uses to generate actions for the entities of the application. In examples where the action rate controller 204 uses an AI model to determine a base decision rate 302, that model is trained in any technically feasible manner. In some examples, a trainer provides training samples that include both state information and labels in the form of desired base decision rates 302 given that state information. In an example, one training sample includes information indicating that an application entity is in a relatively steady, predictable situation (e.g., walking) as well as a relatively longer base decision rate 302, and another training sample includes information indicating that an application entity is in a relatively unpredictable situation (e.g., in combat) as well as a relatively shorter base decision rate 302. Based on the training samples, the AI model is trained to provide reasonable base decision rates 302 given the state of a particular application entity.

In some examples, the action rate controller 204 accepts system performance information 308 and uses this information in determining the base decision rate 302. More specifically, as the base decision rate 302 indicates the base rate at which the action generator 206 should generate actions for application entities, the performance information 308 acts as an additional factor in determining the base decision rate 302. This additional factor allows the action rate controller 204 to adjust the base decision rate 302 based on the amount of available performance. In an example, the action rate controller 204 increases the base decision rate 302 in the event that more computing resources are available and decreases the base decision rate 302 in the event that fewer computing resources are available. The system performance information 308 includes any technically feasible information such as frame rate, CPU idleness, GPU idleness, memory bandwidth availability, or any other information. The system performance information 308 may take into account power availability for the device 100 as well. In other words, the system performance information 308 may include information about the current power level of the device 100, allowing the action rate controller 204 to adjust the base decision rate 302 to increase or decrease power consumption.

Key events 304 are special, unpredictable events that indicate that a higher decision rate than the base decision rate 302 should be used. In an example where an application entity is a non-player character that is walking in a relatively calm environment, an example key event is that an enemy appears. Because the base decisions rates 302 act as predictions of the amount of time that any given action performed by an application entity is valid, unpredictable “key events” do not conform to this prediction. In some implementations, in the event that a key event occurs, the action rate controller 204 generates a decision trigger 306, regardless of how much time is left in accordance with the base decision rate 302. In an example, if the base decision rate indicates that decisions for an application entity should be made once per second, and a key event 304 occurs half way into this one second interval, then the action rate controller 204 will generate a decision trigger 306, thus causing the action generator 206 to generate an action for the application entity. In some examples, the key events are not “binary” but are instead weighted. In other words, key events are associated with a weight. When a key event occurs, the base decision rate 302 is sped up based on the value of the weight. It is possible that such a speed up would result in a decision being necessary immediately or simply that the amount of time until a decision should be made is shortened.

In some examples, the application 202 specifies which events within the application 202 are considered to be key events 304 to the action rate controller 204. More specifically, the application 202 includes indications of which events within the application 202 are considered key events 304. In an example where the application is a video game and the application entity is a non-player character, a key event is a new enemy appearing. In such an example, whatever action the non-player character is performing may no longer be valid if an enemy appears. For example, if the non-player character is walking, the non-player character may need to switch to combat.

The application 202 specifies which events are key events 304 in any technically feasible manner. In an example, the application developer provides the indications of which events are key events to application 202. While the application 202 is executing, the action rate controller 204 or the application 202 detects that one of such events occurs and in response informs the action rate controller 204 that such a key event has occurred. The action rate controller 204 then takes into consideration the fact that a key event has occurred in determining whether to generate a decision trigger 306 as described elsewhere herein.

In some examples, the action rate controller 204 uses the system performance information 308 to interpret the base decision rate 302. In other words, at any given time, the action rate controller 204 is aware of the amount of time that has elapsed since the immediately previous decision trigger 306 was generated. To determine whether to generate a decision trigger 306, the action rate controller 204 determines whether that amount of time is greater than the decision period specified by the base decision rate 302. In examples in which the action rate controller 204 interprets this period based on the base decision rate 302, the action rate controller 204 shortens the base decision rate 302 in the situation that the device 100 is less busy (e.g., has more free resources, for example, the CPU or GPU has more idle cores, more memory bandwidth is available, or the like), and lengthens the base decision rate 302 in the situation that the device 100 is more busy (e.g., has fewer free resources, for example, the CPU or GPU has fewer idle cores, there is less available memory bandwidth, or the like). In an example, for a given base decision rate 302, in a first instance, the amount of free resources is low and in a second instance, the amount of free resources is high. In the first instance, the action rate controller 204 interprets the base decision rate 302 as requiring decisions to be made less frequently than for the second instance. In this example, “the amount of free resources” means any measure of system resources, including but not limited to those mentioned herein. In an example, the amount of free resources is a combination of one or more measures of system resources. In an example, this combination combines a number of different such measures to obtain a score that characterizes the amount of free resources. As the score varies between indicating more free resources and indicating fewer free resources, the speed with which decisions triggers 306 are issues is increased or decreased, respectively. In some examples, an AI model calculates a score based on the measures. More specifically, in such examples, an AI model is trained to generate such scores based on such measures. In such examples, the action rate controller 204 provides the measures to this trained network, which processes the measures to generate a score that is then used as described.

In summary, while the application 202 is executing, the action rate controller 204 determines whether to generate a decision trigger 306. The decision trigger 306 is an indication to the action generator 206 that the action generator should generate an action for an application entity (e.g., a non-player character). In response to the decision trigger 306, the action generator 206 generates an action for the application entity. Generating the action occurs in any technically feasible manner, such as through a trained artificial intelligence model. In various examples, the action generator 206 accepts state information from the application 202 in order to generate an action for the entity. The action rate controller 204 determines whether to generate the decision trigger 306 based on a base decision rate 302 and based on key events 304. The action rate controller 204 generates or receives the base decision rate 302, which indicates how often an action should be generated, if no key events occur (in the case that key events are used in a “binary” mode as defined below). In some examples, where key events are not used in a “binary” mode, the key events are capable of adjusting the base decision rate 302 as described elsewhere herein. In some examples, the base decision rate 302 takes into account system performance information 308 as described elsewhere herein. In conjunction with the action rate controller 204 generating a decision trigger 306 (e.g., after or when the action rate controller 204 generates a decision trigger 306), the action rate controller 204 generates a new base decision rate 302 which indicates how long the action rate controller 204 will wait before generating a new decision trigger 306, if a key event 304 does not occur and key events are used in a “binary” mode (where the “binary” mode is one in which, when a key event occurs, a new base decision rate 302 is generated). Put differently, when the action rate controller 204 generates an action, the action rate controller 204 generates a new base decision rate 302. Then, in the event that the time specified by the base decision rate 302 expires or a key event 304 occurs (in binary mode), the action rate controller 204 generates a new action. In some examples, As stated above, in some implementations, the key event speeds up the base decision rate 302, rather than being a binary toggle for whether an action should occur.

The action rate controller 204 operates on a per-application-entity basis. In other words, operations described herein as being performed by the action rate controller 204 are performed separately for each different application entity. In other words, the action rate controller 204 determines a different base decision rate 302 for different entity and monitors the key events 304 independently for different application entities. In an example, the application 202 has five different application entities. The action rate controller 204 maintains different base decision rates 302 and watches for different key events 304 for each different application entity. In an example, the action rate controller 204 generates decision triggers 306 at different times for each different application entity and thus “restarts” the base decision rate period at different times for each different application entity.

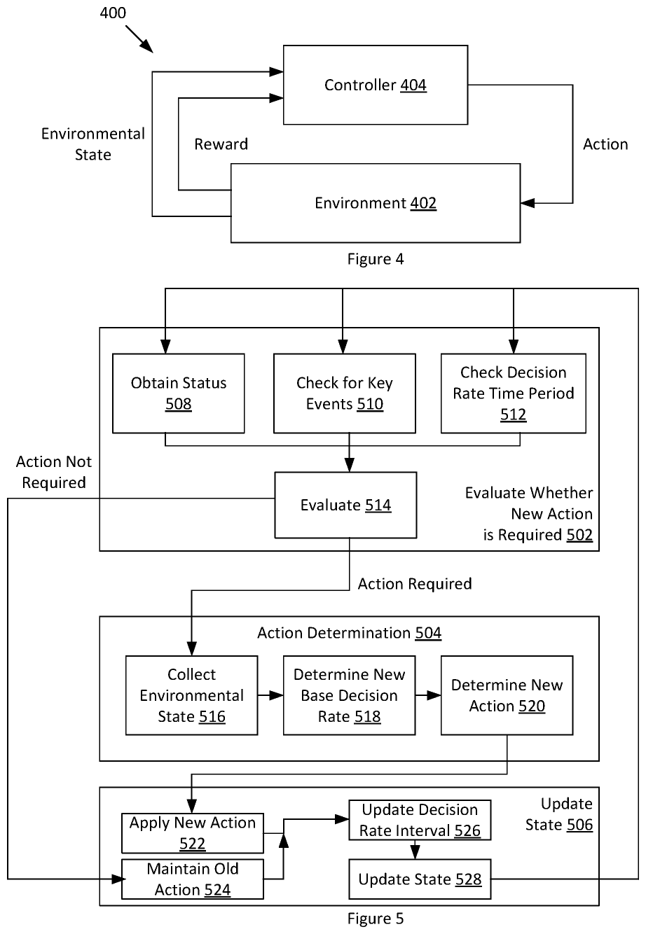

FIG. 4 illustrates a reinforcement learning system 400, according to an example. In some implementations, the action generator 206 uses a trained AI model that is trained in accordance with the system 400 of FIG. 4.

The system 400 includes an environment 402 and a controller 404. In some examples, the environment is the application 202 of FIG. 2A. In other examples, the environment is part of the application 202 of FIG. 2A (in other words, in such examples, the application 202 performs operations that maintain and update data that is considered to be “the environment”). In some examples, the environment 402 and/or the controller 404 is implemented as hardware (e.g., circuitry such as a programmable, configurable, or hard-wired processor), software executing on a processor, or a combination thereof.

The system 400 includes the environment 402 and the controller 404. The environment 402 represents a model that is maintained and updated by the application 202. In an example, the environment 402 is a video game world. The controller 404 trains an AI model based on interactions with the environment 402. More specifically, the controller 404 accepts state from the environment 402 as well as a reward for a previous action, and performs inference with the AI model using the state as input to obtain an action or set of actions from the AI model. The controller 404 applies the action to the environment 402, which modifies its state. The environment 402 provides the new state and a reward to the controller 404, which updates the AI model. The controller 404 repeats this process until the AI model is considered to be trained. As stated, this system 400 is used to train an AI model that would be used to control an application entity as described elsewhere herein. In some examples, the action generator 206 consults this AI model to generate actions that control the application entities.

FIG. 5 is a flow diagram illustrating operations for determining what actions are to be performed by an application entity, according to an example. Generally, the operations include evaluating whether a new action is required 502, determining what the action is 504 (if required), and updating the state of the application 506.

Regarding evaluating whether a new action is required 502, the action rate controller 204 obtains performance metrics 508, checks for key events 510, checks the decision rate time period 512, and evaluates this information 514.

Obtaining the performance metrics 508 includes obtaining metrics that indicate performance of the application 202 and/or of the device 100 in which the application 202 is executing (e.g., the system performance information 308). Examples of metrics are described elsewhere herein, and include frame rate of the application, GPU or CPU idle time, memory bandwidth utilization, or many other example performances that indicate the performance of the device 100 and/or application. Checking for the key events 510 includes determining whether an event indicated as being a key event has occurred in the application 202. Checking the decision rate time period 512 includes determining how much time has passed since the last time a base decision rate 302 was determined, and comparing that amount of time to the base decision rate 302. In an example, it has been half a second since a base decision rate 302 has been determined, and the base decision rate is one second. Thus, it is determined that the amount of time specified by the base decision rate has not yet passed. Evaluating the information 514 is performed as described elsewhere herein. Specifically, the action rate controller 204 determines whether the decision rate time period has elapsed and whether a key event has occurred (in the event that the key event is being used in a binary mode as discussed elsewhere herein). If either of those things has occurred, then the action rate controller 204 determines that a new action should be generated and if neither has occurred, then the action rate controller 204 determines that a new action should not be generated. In some examples, the action rate controller 204 takes into consideration the system performance information 308 as described elsewhere herein.

If an action should be required, then at action determination 504, the action generator 206 collects environmental state 516 from the application, determines a new base decision rate 518 (e.g., using an AI model), and determines a new action 520 (again, e.g., using an AI model).

At update state 506, if a new action was required, the application 202 applies the new action 522, and if no new action was required, then the application 202 does not apply the new action 524. In either case, the application rate controller 204 updates the decision rate interval 526 and the application 202 updates the state 528. The operations described repeat while the application 202 is running.

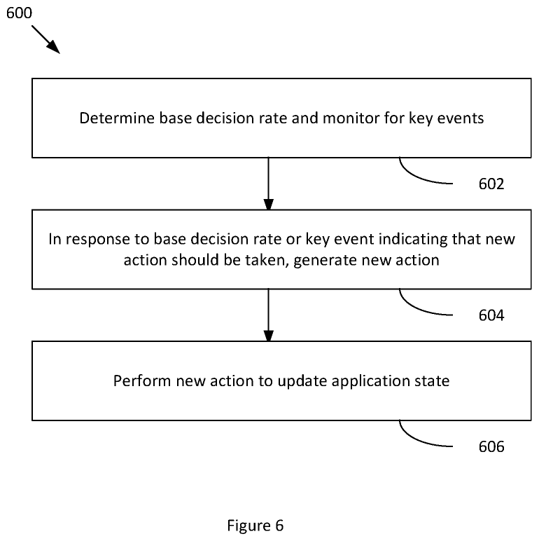

FIG. 6 is a flow diagram of a method 600 for controlling an application entity such as a non-player character in a video game, according to an example. Although described with respect to the system of FIGS. 1-5, those of skill in the art will understand that any system configured to perform the steps of the method 600 in any technically feasible order falls within the scope of the present disclosure.

At step 602, an AI system 200 determines a base decision rate 302 and monitors for key events 304. In various examples, the AI system 200 determines the base decision rate 302 in any technically feasible manner. In some examples, the action rate controller 204 determines the base decision rate 302 based on the state of the application 202. In some examples, the action rate controller 204 includes hard-coded rules that accept the state of the application as input, processes that state, and generates a base decision rate 302 as a result. In some examples, the hard-coded rules include any technically feasible logic. In some examples, the hard-coded rules indicate that if there are no enemies in the vicinity of an NPC, then the base decision rate 302 is a slower rate than if there are enemies in the vicinity of the NPC. Any technically feasible hard-coded rules could be used. In some examples, the action rate controller 204 uses one or more lookup tables to determine the base decision rate 302. In various examples, the lookup tables map application state values to base decision rates 302. In some examples, the application state values include values for various aspects of state of the application (e.g., the position of the NPC, the position of enemies, the distance of the NPC compared with enemies, the number of enemies within a given radius from the NPC, the action that is currently being performed by the NPC, or any other aspect of state of the application). The lookup tables map these different values to different decision rates, such that the action rate controller 204 is able to determine the base decision rate 302 based on such values. In some examples, the action rate controller 204 generates a base decision rate 302 utilizing a trained AI model. More specifically, a trained AI model accepts various aspects of application state (e.g., any such information described elsewhere herein, including but not limited to the position of the NPC, the position of enemies, the action that is currently being performed by the NPC, or any other aspect of state of the application) as input, processes this input and generates a base decision rate 302 as output. In various examples, the trained AI model operates and is trained as described with respect to FIG. 3. In some examples, in addition to or as an alternative to the AI model-based technique, the hard-coded rules based technique, or the lookup table-based technique, the action rate controller 204 accepts system performance information 308 and uses this information in determining the base decision rate. In various examples, the system performance information 308 indicates how “busy” the system is (e.g., a device executing the application 202 is being executed on), and thus how much additional work the system can perform. Thus, in some examples, the action rate controller 204 utilizes the system performance information 308 to adjust the base decision rate 302. Example techniques for performing such adjustments are described elsewhere herein, such as with respect to FIG. 3.

The key events are special unpredictable events that indicate that a higher decision rate than the base decision rate 302 should be used. In an example, where there are no enemies near a non-player character, a first base decision rate 302 is determined. Then, an enemy appears and that base decision rate may no longer be valid. Additional details for key events are provided with respect to FIG. 3.

In some examples, in addition to determining the base decision rate and monitoring for key events, step 602 additionally includes determining the state of an application 202, the amount of time that has elapsed since the AI system 200 determined what action to take, performance metrics of the application 202 or device 100, or any other relevant information.

At step 604, in response to a base decision rate or key event indicating that a new action should be generated, the action generator 206 determines a new action. Step 604 includes both determining that a new action should be generated as well as determining the action. In various examples, determining that a new action should be generated includes one or more of examining the time since the most recent new action was determined, examining the base decision rate 302, and examining any key events 304 that occurred. As described elsewhere herein, in some examples, in the event that the amount of time specified by the base decision rate 302 has elapsed or that a key event has occurred, the AI system 200 determines that an action is required. In the event that neither such event has occurred, the AI system 200 determines that an action is not to be generated. In some examples, if there is spare performance (i.e., based on the performance metrics maintained), then the AI system 200 determines that an action is to be generated even if the amount of time specified by the base decision rate 302 has not elapsed or that a key event has not occurred. In some examples, the AI system 200 modifies the base decision rate 302 based on the performance information to obtain a new base decision rate. In some examples, for a first level of performance that indicates a first level of available processing throughput, the AI system 200 makes the base decision rate 302 faster and for a second level of performance that indicates less available processing throughput than the first level of available processing throughput, the Al system 200 makes the base decision rate 302 slower. In some examples, the AI system 200 additionally or alternatively modifies the base decision rate 302 based on whether a key event 304 has occurred since the last time an action was generated. In an example, the AI system 200 makes the rate faster in the event that a key event 304 has occurred since the last time an action was generated and does not make the rate faster in the event that a key event 304 has not occurred since the last time an action was generated. Additional detail about how the AI system 200 determines whether an action should be generated is provided elsewhere herein, such as with respect to the action rate controller 204 described in FIGS. 2-3 and the action determination 504 of FIG. 5.

Step 604 also includes generating a new action. Such activity is described elsewhere herein, such as with respect to step 206. Any technically feasible mechanism for generating an action may be used. In an example, the action generator 206 provides application state to a trained AI model, which processes the state to generate an action. A wide variety of mechanisms exist for generating the action. The specific manner in which such an action is generated is dependent on how the application 202 is implemented. In some examples, the application 202 performs inference with a trained AI model based on the state of the application to determine an action. At step 606, the application 202 performs the newly generated action to update the application state. The action that is performed is dependent on how the application 202 is implemented. In some examples, the application 202 determines an action for an application agent such as an NPC and performs such action. In such examples, the action is any action that the application 202 permits the application agents to take. In some examples, the actions are actions such as jumping, attacking, moving, changing equipment, taking cover, or performing any other action that a non-player character can take.

It should be understood that many variations are possible based on the disclosure herein. Although features and elements are described above in particular combinations, each feature or element may be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the AI system 119, IO devices 117, auxiliary processor(s) 114, action generator 206, or action rate controller 204, are implemented fully in hardware (e.g., circuitry such as a programmable processor, fixed function processor, programmable logic device, field programmable gate array, analog processor, analog circuitry, or any other hardware and/or circuitry), fully in software executing on processing units, or as a combination thereof. In various examples, any of the hardware described herein includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements features of the disclosure.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
determining a base decision rate;
monitoring for key events; and
based on the base decision rate and the monitoring, determining a time at which to generate an action to be performed by an application entity of an application.

2. The method of claim 1, wherein the base decision rate and key events are based on state information for an application.

3. The method of claim 2, wherein the state information includes information about the application entity within the application or performance information about the application and a device executing the application.

4. The method of claim 1, wherein determining the base decision rate is based on the state information.

5. The method of claim 3, wherein determining the base decision rate is based on performance information of the state information.

6. The method of claim 1, wherein the key events are events specified by the application, and determining the time at which to generate the action includes detecting that one or more of the key events has occurred.

7. The method of claim 6, wherein determining the time at which to generate the action includes determining that the action is to be generated in response to a key event occurring.

8. The method of claim 1, wherein determining the base decision rate comprises consulting an artificial intelligence model.

9. The method of claim 1, wherein the application is a video game and the application entity is a non-player character.

10. A system comprising:
a memory configured to store instructions for an application; and
a processor configured to:
determine a base decision rate;
monitor for key events; and
based on the base decision rate and the monitoring, determine a time at which to generate an action to be performed by an application entity of the application.

11. The system of claim 10, wherein the base decision rate and key events are based on state information for an application.

12. The system of claim 11, wherein the state information includes information about the application entity within the application or performance information about the application and a device executing the application.

13. The system of claim 10, wherein determining the base decision rate is based on the state information.

14. The system of claim 12, wherein determining the base decision rate is based on performance information of the state information.

15. The system of claim 10, wherein the key events are events specified by the application, and determining the time at which to generate the action includes detecting that one or more of the key events has occurred.

16. The system of claim 15, wherein determining the time at which to generate the action includes determining that the action is to be generated in response to a key event occurring.

17. The system of claim 10, wherein determining the base decision rate comprises consulting an artificial intelligence model.

18. The system of claim 10, wherein the application is a video game and the application entity is a non-player character.

19. A non-transitory computer-readable medium storing instructions that, when executed by a processor, cause the processor to perform operations comprising:
determining a base decision rate;
monitoring for key events; and
based on the base decision rate and the monitoring, determining a time at which to generate an action to be performed by an application entity of an application.

20. The non-transitory computer-readable medium of claim 19, wherein the base decision rate and key events are based on state information for an application.
